(19) United States
(12) Patent Application Publication
(10) Pub. No.: US 2015/0105578 A1
(43) Pub. Date: Apr. 16, 2015

(54) Novel Acid Corrosion Inhibitor

(71) Applicant: Ambrish Kamdar, Sugarland, TX (US)

(72) Inventor: Ambrish Kamdar, Sugarland, TX (US)

(21) Appl. No.: 14/499,141

(22) Filed: Oct. 6, 2014

(51) Int. Cl. C09K 8/54

(52) U.S. Cl. CPC C09K 8/54; C09K 2208/32
USPC 558/401

(57) ABSTRACT

Acids, such as hydrochloric acid, are pumped down in to the formation in acidizing treatments of oil & gas wells, thru metal pipes/tubing. Corrosion Inhibition of these metal surfaces (pipes, tubing, etc) has been extensively studied. Most known acid corrosion inhibitors (ACI) and acid corrosion inhibitors currently used in the oilfield contain ingredients that are an environmental concern or have poor Health, Safety and Environmental (HSE) characteristics. This invention relates to the discovery of a Novel Acid Corrosion Inhibitor. Aromatic Nitriles, especially Cinnamyl Nitrile, when added to the acid in effective amounts, offers acceptable rates of corrosion inhibition.

Cinnamyl Nitrile can be substituted in place of ingredients that have poor HSE characteristics, to improve the HSE characteristics of acid corrosion inhibitors, without sacrificing corrosion inhibition performance. Cinnamyl Nitrile can also be added to formulations of know acid corrosion inhibitors being used in the oilfield to improve their corrosion inhibition performance.

### TECHNICAL FIELD OF THE INVENTION

This Invention relates to the acid stimulation of oil & gas wells, and in particular to acidizing treatments and methods of using such acid fluids in treating formations having low permeability.

### BACKGROUND OF THE INVENTION

Using aqueous acid solutions to acidize oil & gas wells is well known. Typically, an aqueous acid solution is pumped through the well bore into the formation where it reacts with materials in the formation to increase the permeability thereof. The increased permeability brings about an increase in the flow of hydrocarbons from the formation into the well bore.

Many compositions have been proposed as corrosion inhibitors for ferrous metals in oil field applications. Many of said compositions exhibit acceptable rates of inhibition however they contain ingredients like Methanol, Acetylenic Compounds, Propargyl Alcohol, EthylOctynol, NonylPhenol, Benzyl Chloride, etc which are either toxic, flammable and/or corrosive and some also feature on the EPA's Priority Pollutants List. It would be desirable to have a corrosion inhibitor consisting of components with good HSE characteristics (ones which are Non-Toxic, Inflammable, Not-Corrosive, Biodegradable or have Short Half Lives in the environment, Non-Marine Pollutants, etc), which could be used in effective amounts and would exhibit acceptable rates of inhibition.

The following patents are representative of Corrosion Inhibitor formulations with components that exhibit poor HSE characteristics U.S. Pat. No. 3,077,454; U.S. Pat. No. 3,669,613; U.S. Pat. No. 4,493,775; U.S. Pat. No. 5,366,643; U.S. Pat. No. 5,441,929; U.S. Pat. No. 5,697,443.

### SUMMARY OF THE INVENTION

The present invention is such a film forming corrosion inhibitor composition comprising:

A. Cinnamyl Nitrile

B. Other know corrosion inhibitor constituents like
a. Cinnamic Aldehyde
b. “Quinolinium Quats” like Naphthyl Methyl Quinolinium Chloride, etc

C. Surfactants
a. Ethoxylated Fatty Acid Esters
b. Fatty Acid Esters

D. Solvents like
a. Propylene Glycol
b. Water

Corrosion Inhibitor of the present invention exhibits “acceptable inhibition rate” when used in “effective amounts” without the use of ingredients like Methanol, Acetylenic Compounds, Propargyl Alcohol, EthylOctynol, NonylPhenol, Formaldehyde, Benzyl Chloride, Antimony, etc which are either toxic, flammable, corrosive, marine pollutants, have large half lives in the environment and/or are not biodegradable (considered to have poor HSE characteristics).

Hence Corrosion Inhibitor of the present invention exhibits “acceptable inhibition rate” when used in “effective amounts” using ingredients that have excellent HSE characteristics (are non-toxic, inflammable, not-corrosive, not marine pollutants, have short half lives in the environment and/or are biodegradable).

Acceptable Inhibition Rate is considered to be, 0.05 lbs loss in weight of the metal sample when 1 sq ft of the test metal sample in submerged in acid for a period of 24 hours, by those individuals skilled in the art of acidizing wells. Effective amounts are usually considered to be, 1 gpt (0.1% by volume or 1 gallon of formulated corrosion inhibitor per thousand gallons of acid) to 10 gpt (1% by volume or 10 gallon of formulated corrosion inhibitor per thousand gallons of Acid), by those individuals skilled in the art of acidizing wells.

### DETAILED DESCRIPTION OF THE INVENTION

The acid corrosion inhibitor formulation of the present invention includes Cinnamyl Nitrile as the active ingredient along with a number of additional components like surfactants, solvents, emulsifiers, etc and may include previously known corrosion inhibitors that have acceptable HSE characteristics like Cinnamic Aldehyde, etc.

Adding effective amounts of Cinnamyl Nitrile to other know acid corrosion inhibitor compositions improves their corrosion inhibition properties. In lab trials conducted, Cinnamyl Nitrile has been added to corrosion inhibitor formulated as taught by U.S. Pat. No. 6,068,056 and test results of the corrosion inhibitor so formulated exhibit better corrosion inhibition rates due to the presence of Cinnamyl Nitrile.

It is possible to substitute Cinnamyl Nitrile for ingredients which have poor HSE characteristics in other know acid corrosion inhibitor compositions and retain acceptable corrosion inhibition rates. In lab trials conducted, Cinnamyl Nitrile was been substituted in place of EthylOctynol as taught in U.S. Pat. No. 4,493,775; test results of the corrosion inhibitor so formulated also exhibit better corrosion inhibition rates due to the presence of Cinnamyl Nitrile.

Cinnamyl Nitrile can be synthesized in a number of ways know to people skilled in the art of organic chemistry. Precursors that will generate Cinnamyl Nitrile in situ under wellbore conditions can also be used instead of Cinnamyl Nitrile.

While Cinnamyl Nitrile is specifically named as the ingredient that improves HSE characteristics and corrosion inhibition performance; other Aromatic Nitriles are expected to accomplish the same effect.

### SPECIFIC EXAMPLES

### Example 1

A bottle with a cap that has an arrangement to suspend a pipe section is placed in an oil bath at the desired temperature for the desired time. Pipe section to be tested is degreased in acetone and sodium hydroxide 20% for 15 minutes each; scrubbed with a bristle brush in hot soapy water, rinsed and dried. Pipe section is weighed after drying. Pipe section is suspended in 500 ml of acid for the desired time while the bath is held at the desired test temperature. Pipe section is removed after being submerged in the acid at the end of the desired time, washed under water, scrubbed with a bristle brush, dried and weighed again to calculate loss in weight.

### Acid #1=7.5% Hydrochloric Acid

### Acid #2=15% Hydrochloric Acid

### Acid #3=28% Hydrochloric Acid

### Metal #1=L80

### Metal #2=N80

### Temperature=150 deg F.

Time=24 hours

### Results:

| | | | Cl | Corrosion Rate |
|---|---|---|---|---|
| Test # | Acid | Metal | Compostion | (lbs/sq/ft) |
| 1 | 1 | 1 | None | 0.343 |
| 2 | 2 | 2 | None | 0.476 |
| 3 | 2 | 1 | None | 0.436 |
| 4 | 1 | 2 | None | 0.337 |

### Example 2

A bottle with a cap that has an arrangement to suspend a pipe section is placed in an oil bath at the desired temperature for the desired time. Pipe section to be tested is degreased in acetone and sodium hydroxide 20% for 15 minutes each; scrubbed with a bristle brush in hot soapy water, rinsed and dried. Pipe section is weighed after drying. Pipe section is suspended in 500 ml of acid for the desired time while the bath is held at the desired test temperature. Pipe section is removed after being submerged in the acid at the end of the desired time, washed under water, scrubbed with a bristle brush, dried and weighed again to calculate loss in weight.

### Acid #1=7.5% Hydrochloric Acid

### Acid #2=15% Hydrochloric Acid

### Acid #3=28% Hydrochloric Acid

### Metal #1=L80

### Metal #2=N80

### Temperature=150 deg F.

Time=24 hours

### Corrosion Inhibitor Composition #1=Cinnamyl Nitrile Formulation

100 ml Cinnamyl Nitrile, approx 90% pure is mixed with 100 ml aqueous solution of Cocoamidopropyl Betaine, approx 35% pure at room temperature on a magnetic stirrer.

### Corrosion Inhibitor Composition #2=NMQC Formulation

100 gm Naphthylmethylquinolinium Chloride, approx 90% pure is mixed with 50 gm of an aqueous solution of Cocoamidopropyl Betaine, approx 35% pure and 50 gm Propylene Glycol, approx 99% pure at room temperature on a magnetic stirrer.

### Corrosion Inhibitor Composition #3=Cinnamic Aldehyde Formulation

100 gm Cinnamic Aldehyde, approx 99% pure is mixed with 50 gm of an aqueous solution of Cocoamidopropyl Betaine, approx 35% pure and 50 gm Propylene Glycol, approx 99% pure at room temperature on a magnetic stirrer.

### Corrosion Inhibitor Composition #4=EthylOctynol Formulation

100 gm EthylOctynol, approx 95% pure is mixed with 50 gm of an aqueous solution of Cocoamidopropyl Betaine, approx 35% pure and 50 gm Propylene Glycol, approx 99% pure at room temperature on a magnetic stirrer.

### Results:

| | | | Cl | Corrosion Rate |
|---|---|---|---|---|
| Test # | Acid | Metal | Compostion | (lbs/set) |
| 1 | 1 | 1 | 1 @ 1 gpt | 0.016 |
| 2 | 1 | 1 | 2 @ 2 gpt | 0.025 |
| 3 | 1 | 2 | 3 @ 2 gpt | 0.031 |
| 4 | 1 | 2 | 4 @ 2 gpt | 0.039 |
| 5 | 2 | 1 | 1 @ 2 gpt | 0.017 |
| 6 | 2 | 1 | 2 @ 2 gpt | 0.027 |
| 7 | 2 | 2 | 3 @ 2 gpt | 0.033 |
| 8 | 2 | 2 | 4 @ 2 gpt | 0.041 |
| 9 | 3 | 1 | 1 @ 2 gpt | 0.020 |
| 10 | 3 | 1 | 2 @ 2 gpt | 0.031 |
| 11 | 3 | 2 | 3 @ 2 gpt | 0.037 |
| 12 | 3 | 2 | 4 @ 2 gpt | 0.035 |
| 13 | 1 | 1 | None | 0.341 |
| 14 | 1 | 1 | 2 @ 4 gpt | 0.023 |
| 15 | 1 | 1 | 3 @ 4 gpt | 0.029 |
| 16 | 1 | 1 | 4 @ 4 gpt | 0.027 |

### Example 3

A bottle with a cap that has an arrangement to suspend a pipe section is placed in an oil bath at the desired temperature for the desired time. Pipe section to be tested is degreased in acetone and sodium hydroxide 20% for 15 minutes each; scrubbed with a bristle brush in hot soapy water, rinsed and dried. Pipe section is weighed after drying. Pipe section is suspended in 500 ml of acid for the desired time while the bath is held at the desired test temperature. Pipe section is removed after being submerged in the acid at the end of the desired time, washed under water, scrubbed with a bristle brush, dried and weighed again to calculate loss in weight.

### Acid #1=7.5% Hydrochloric Acid

### Acid #2=15% Hydrochloric Acid

### Acid #3=28% Hydrochloric Acid

### Metal #1=L80

### Metal #2=N80

### Temperature=150 deg F.

Time=24 hours

### Cinnamyl Nitrile ADDITIVE #1=Cinnamyl Nitrile Formulation

100 ml Cinnamyl Nitrile, approx 90% pure is mixed with 100 ml of Ethoxylated Sorbitan Monooleate, approx 97% pure at room temperature on a magnetic stirrer.

### Corrosion Inhibitor Composition #2=NMQC Formulation

100 gm Naphthylmethylquinolinium Chloride, approx 90% pure is mixed with 100 ml Ethoxylated Sorbitan Monooleate, approx 97% pure and 50 gm Propylene Glycol, approx 99% pure at room temperature on a magnetic stirrer.

### Corrosion Inhibitor Composition #3=Cinnamic Aldehyde Formulation

100 gm Cinnamic Aldehyde, approx 99% pure is mixed with 100 ml Ethoxylated Sorbitan Monooleate, approx 97% pure and 50 gm Propylene Glycol, approx 99% pure at room temperature on a magnetic stirrer.

### Corrosion Inhibitor Composition #4=EthylOctynol Formulation

100 gm EthylOctynol, approx 95% pure is mixed with 100 ml Ethoxylated Sorbitan Monooleate, approx 97% pure and 50 gm Propylene Glycol, approx 99% pure at room temperature on a magnetic stirrer.

### Results:

| | | | Cl | Cinnamyl Nitrile | Corrosion Rate |
|---|---|---|---|---|---|
| Test # | Acid | Metal | Compostion | Additive | (lbs/sq/ft) |
| 1 | 1 | 1 | None | 1 @ 0.25 gpt | 0.020 |
| 2 | 1 | 1 | 2 @ 2 gpt | 1 @ 0.25 gpt | 0.020 |
| 3 | 1 | 2 | 3 @ 2 gpt | 1 @ 0.25 gpt | 0.024 |
| 4 | 1 | 2 | 4 @ 2 gpt | 1 @ 0.25 gpt | 0.023 |
| 5 | 2 | 1 | None | 1 @ 0.25 gpt | 0.022 |
| 6 | 2 | 1 | 2 @ 2 gpt | 1 @ 0.25 gpt | 0.021 |
| 7 | 2 | 2 | 3 @ 2 gpt | 1 @ 0.25 gpt | 0.027 |
| 8 | 2 | 2 | 4 @ 2 gpt | 1 @ 0.25 gpt | 0.025 |
| 9 | 1 | 1 | None | 1 @ 0.5 gpt | 0.019 |
| 10 | 1 | 1 | 2 @ 2 gpt | 1 @ 0.5 gpt | 0.019 |
| 11 | 1 | 2 | 3 @ 2 gpt | 1 @ 0.5 gpt | 0.022 |
| 12 | 1 | 2 | 4 @ 2 gpt | 1 @ 0.5 gpt | 0.021 |
| 13 | 2 | 1 | None | 1 @ 0.5 gpt | 0.020 |
| 14 | 1 | 1 | 2 @ 4 gpt | 1 @ 0.5 gpt | 0.018 |
| 15 | 1 | 1 | 3 @ 4 gpt | 1 @ 0.5 gpt | 0.025 |
| 16 | 1 | 1 | 4 @ 4 gpt | 1 @ 0.5 gpt | 0.024 |

What is claimed:

1. A Novel Acid Corrosion Inhibitor consisting of an Aromatic Nitrile compound, used independently or in conjunction with other acid corrosion inhibitors, offers excellent corrosion inhibition rates of metal surfaces that come in contact with mineral acids.

2. Aromatic Nitrile compound of claim 1 is Cinnamyl Nitrile

3. By using Cinnamyl Nitrile, it is possible to formulate a corrosion inhibitor which has acceptable inhibition rates without the use of conventional ingredients that have poor Health, Safety and Environmental (HSE) characteristics. Corrosion Inhibitors currently in use contain ingredients like Methanol, Acetylenic Compounds, Propargyl Alcohol, EthylOctynol, NonylPhenol, Formaldehyde, Benzyl Chloride, Antimony, etc which are either toxic, flammable, corrosive, marine pollutants, have large half lives in the environment and/or are not biodegradable.
